(19) United States
(12) Patent Application Publication
(10) Pub. No.: US 2026/0291066 A1
(43) Pub. Date: Sep. 24, 2026

(54) COMBO ANTENNA MODULE AND METHOD FOR MANUFACTURING SAME

(71) Applicant: AMOTECH CO., LTD., Incheon (KR)

(72) Inventors: Jinwon NOH, Incheon (KR); Hongdae JUNG, Incheon (KR); Hyungil BAEK, Incheon (KR); Donghyun IM, Incheon (KR); Euijin JUNG, Incheon (KR); Kisang LIM, Incheon (KR); Chungha BACK, Incheon (KR); Jooseung MAENG, Incheon (KR)

(73) Assignee: AMOTECH CO., LTD., Incheon (KR)

(21) Appl. No.: 19/690,498

(22) Filed: May 28, 2026

Related U.S. Application Data
(62) Division of application No. 17/797,100, filed on Jan. 25, 2021.

(30) Foreign Application Priority Data
Feb. 3, 2020 (KR) 10-2020-0012786
Mar. 19, 2020 (KR) 10-2020-0033906
Mar. 19, 2020 (KR) 10-2020-0033911
Mar. 19, 2020 (KR) 10-2020-0033912

(51) Int. Cl. H01Q 5/35; H01Q 1/24; H01Q 1/38; H01Q 1/48; H04B 5/43

(52) U.S. Cl. CPC H01Q 5/35; H01Q 1/243; H01Q 1/38; H01Q 1/48; H04B 5/43

(57) ABSTRACT

Disclosed is a combo antenna module and a method for manufacturing the same, in which a combo antenna of a low frequency band and an antenna of a high frequency band are integrated to minimize the mounting space and thickness while maintaining the same level of antenna performance. The disclosed combo antenna module comprises: a first antenna in which a first antenna pattern having a first operation frequency is disposed, and an attachment area not overlapping with the first antenna pattern is defined; and a second antenna which is disposed in the attachment area and has a second antenna pattern having a second operation frequency higher than the first operation frequency and disposed on the upper surface thereof, wherein the dielectric loss value of the second antenna is lower than the dielectric loss value of the first antenna.

### TECHNICAL FIELD

This application is a divisional application of U.S. application Ser. No. 17/797,100, filed on Aug. 2, 2022, which is herein incorporated by reference in its entirety.

The present disclosure relates to a combo antenna module and a method of manufacturing the same, and more specifically, to a combo antenna module mounted on an electronic device and resonating in a plurality of frequency bands, and a method of manufacturing the same.

### BACKGROUND ART

A short-range wireless communication technology is a technology for transmitting and receiving data by connecting surrounding devices and a network. Recently, as the short-distance wireless communication technology has become common, a technology of acquiring position information using not only network connection but also the short-range wireless communication technology has been developed, and a technology of acquiring accurate real-time position information has been developed to use the position information acquired through the short-range wireless communication technology in various fields.

An ultra-wide band (UWB) communication technology is attracting attention as a short-range wireless communication for acquiring position information. The UWB communication technology may provide a wireless positioning and communication function having high precision through an impulse signal. The UWB communication technology has a transmission distance of about 10 m to about 1 km while using a frequency band of about 3.1 GHz to about 10.6 GHz. The UWB communication technology has excellent time resolution with a few nsec pulses, and thus it is advantageous for distance measurement, and it is possible to implement low power with a low duty cycle. Accordingly, the UWB communication technology is being used in various fields including mobile, automobile, IoT, and industrial markets.

Meanwhile, as thicknesses of portable devices decrease and battery capacities thereof increase, the need for combo antenna modules in which an NFC antenna, a WPC antenna, an electronic payment antenna pattern, and the like are coupled is emerging due to issues related to antenna thickness and mounting space and cost saving issues.

Conventional combo antenna modules are a low frequency band antenna of about 13.56 MHz or less, and the UWB antenna modules are a high frequency band antenna of about 3.1 GHz to 10.6 GHz. The combo antenna module and the UWB antenna module have differences in antenna structure and required material characteristics due to a difference in operation frequency bands.

Accordingly, the combo antenna module and the UWB antenna module are separately manufactured and mounted on portable devices, and there is a problem in that a mounting space is insufficient in the portable devices that become light, thin, short, and compact.

In addition, the UWB antenna module is manufactured by using an expensive insulating substrate having a low dielectric constant (i.e., a low dielectric loss value) as a base in order to implement performance in a high frequency band, and the combo antenna module having a relatively low frequency band is manufactured by using a general insulating substrate as a base.

At this time, the combo antenna module may also be manufactured by using the same insulating substrate (i.e., a low dielectric constant, a low dielectric loss value) as that of the UWB antenna module as a base, but there is a problem in that a unit price of the antenna module increases due to the use of the expensive insulating substrate, and the thickness of the antenna module is restricted.

### SUMMARY OF INVENTION

### Technical Problem

The present disclosure has been proposed to solve the above problems, and an object of the present disclosure is to provide a combo antenna module, which maintains the same level of antenna performance while minimizing a mounting space and a thickness by integrating a combo antenna of a low frequency band and an antenna of a high frequency band, and a method of manufacturing the same.

### Solution to Problem

In order to achieve the object, a combo antenna module according to an embodiment of the present disclosure includes a first antenna including a first antenna pattern having a first operation frequency, and having an attachment area not overlapping the first antenna pattern defined therein and a second antenna including a second antenna pattern having a second operation frequency higher than the first operation frequency, and disposed in the attachment area defined in the first antenna.

In order to achieve the object, a method of manufacturing a combo antenna module includes preparing a first base substrate having a first dielectric loss value, and having a metal layer formed thereon, forming an attachment area on the first base substrate by removing a part of the metal layer, preparing a second antenna having a second antenna pattern formed thereon, and attaching the second antenna to the attachment area.

### Advantageous Effects of Invention

According to the present disclosure, to the combo antenna module can maintain the same level of antenna performance while minimizing a mounting space and a thickness by integrally forming the combo antenna of the low frequency band and the antenna of the high frequency band. In other words, the combo antenna module can maintain the same level of antenna performance while reducing the thickness by the ground pattern by forming the ground pattern connected to the second antenna on the rear surface of the first antenna compared to the conventional combo antenna module in which two independent antennas are simply bonded.

In addition, the combo antenna module and the method of manufacturing the same can reduce the number of FPCB processes and the number of assembly processes, and reduce the unit price by commonly using the terminal portion connector.

In addition, the combo antenna module and the method of manufacturing the same can improve product reliability according to the integrated structure and minimize the antenna mounting space.

### BRIEF DESCRIPTION OF DRAWINGS

FIG. 1 is a view for describing a combo antenna module according to a first embodiment of the present disclosure.

FIGS. 2 and 3 are views for describing a first antenna in FIG. 1.

FIGS. 4 and 5 are views for describing a second antenna in FIG. 1.

FIG. 6 is a view for describing a modified example of the combo antenna module according to the first embodiment of the present disclosure.

FIG. 7 is a flowchart for describing a method of manufacturing the combo antenna module according to the first embodiment of the present disclosure.

FIG. 8 is a view for describing a combo antenna module according to a second embodiment of the present disclosure.

FIG. 9 is a view for describing a second antenna in FIG. 8.

FIG. 10 is a view for describing a modified example of the combo antenna module according to the second embodiment of the present disclosure.

FIG. 11 is a flowchart for describing a method of manufacturing the combo antenna module according to the second embodiment of the present disclosure.

FIG. 12 is a view for describing a combo antenna module according to a third embodiment of the present disclosure.

FIG. 13 is a view for describing a second antenna in FIG. 12.

FIG. 14 is a view for describing a modified example of the combo antenna module according to the third embodiment of the present disclosure.

FIGS. 15 and 16 are flowcharts for describing a method of manufacturing the combo antenna module according to the third embodiment of the present disclosure.

### DESCRIPTION OF EMBODIMENTS

Hereinafter, the most preferred embodiments of the present disclosure will be described with reference to the accompanying drawings in order to specifically describe the embodiments so that those skilled in the art to which the present disclosure pertains can easily implement the technical spirit of the present disclosure. First, in adding reference numerals to the components of each drawing, it should be noted that the same components have the same reference numerals as much as possible even if they are illustrated in different drawings. In addition, in describing the present disclosure, when it is determined that the detailed description of the related well-known configuration or function can obscure the gist of the present disclosure, the detailed description thereof will be omitted.

First, in adding reference numerals to the components of each drawing, it should be noted that the same components have the same reference numerals as much as possible even if they are illustrated in different drawings.

In addition, in describing embodiments of the present disclosure, when it is determined that the detailed description of the related well-known configuration or function can obscure the gist of the present disclosure, the detailed description thereof will be omitted. In an embodiment of the present disclosure, terminals formed through an upper coverlay, a lower coverlay, a silk printing, and an SMT process, which are a general configuration in an FPCB type antenna, will be omitted from a detailed description.

In addition, in the description of embodiments of the present disclosure, when it is described that a certain structure is disposed or formed “on an upper surface” or “on a lower surface” of another structure, the description should be interpreted as including not only a case in which these structures come into contact with each other but also a case in which a third structure is interposed between these structures.

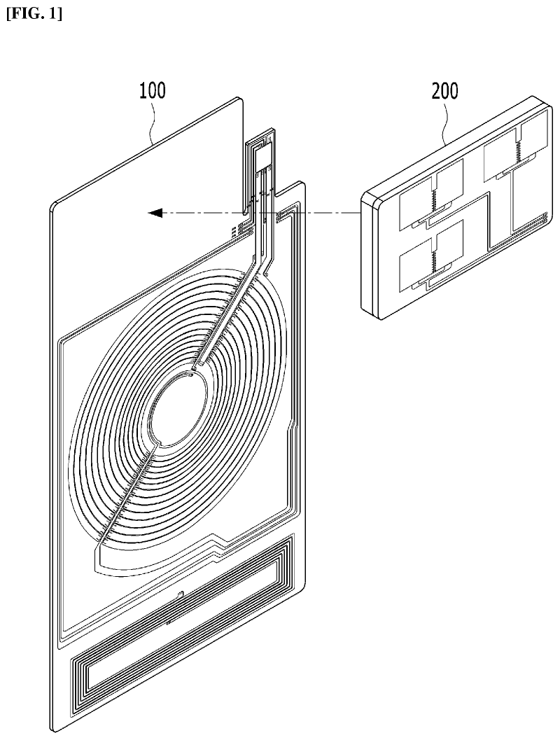

Referring to FIG. 1, a combo antenna module according to a first embodiment of the present disclosure is configured to include a first antenna 100 and a second antenna 200. The first antenna 100 and the second antenna 200 have different dielectric loss values and operating frequencies. At this time, as an example, the first antenna 100 operates as an antenna resonating in at least one of a WPC frequency band, an NFC frequency band, and an MST frequency band, and the second antenna 200 operates as an antenna resonating in a UWB frequency band.

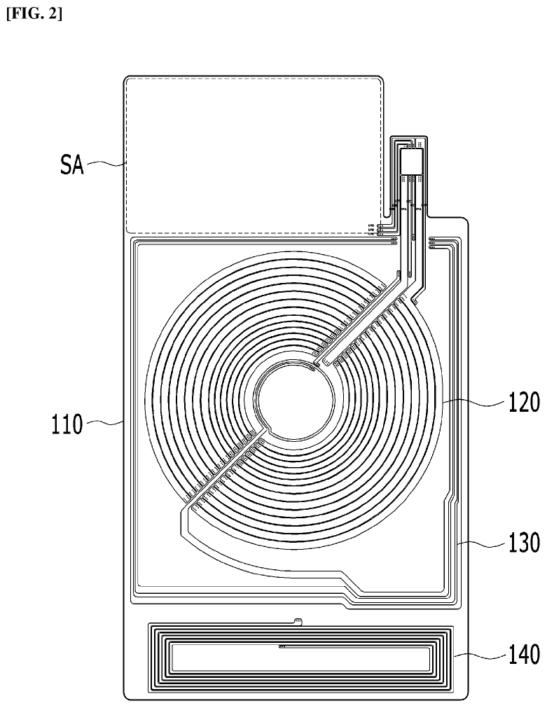

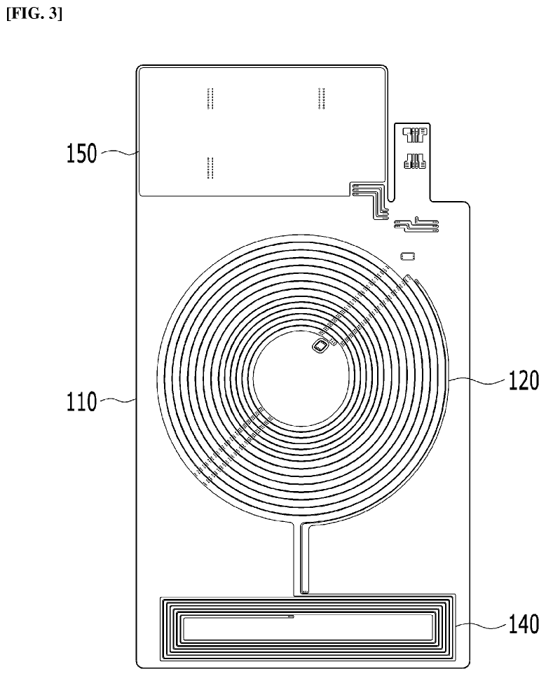

Referring to FIGS. 2 and 3, the first antenna 100 includes a plurality of antenna patterns having different operating frequencies. At this time, the first antenna 100 has a dielectric loss value higher than a dielectric loss value of the second antenna 200, and an operation frequency lower than an operation frequency of the second antenna 200.

As an example, the first antenna 100 includes a wireless power transmission antenna pattern 120 for wireless power transmission, a short-range communication antenna pattern 130 for short-range communication, and an electronic payment antenna pattern 140 for electronic payment.

Here, in order to easily describe the first embodiment of the present disclosure, it has been described in FIGS. 2 and 3 that the first antenna 100 includes all of the wireless power transmission antenna pattern 120, the short-range communication antenna pattern 130, and the electronic payment antenna pattern 140 as an example, but is not limited thereto and may also be configured to include one or two antenna patterns among the wireless power transmission antenna pattern 120, the short-range communication antenna pattern 130, and the electronic payment antenna pattern 140.

Of course, the first antenna 100 may also be configured to further include an antenna pattern resonating in a frequency band different from those of the wireless power transmission antenna pattern 120, the short-range communication antenna pattern 130, and the electronic payment antenna pattern 140.

The first antenna 100 may also be composed of an antenna pattern resonating in a frequency band different from those of the wireless power transmission antenna pattern 120, the short-range communication antenna pattern 130, and the electronic payment antenna pattern 140.

The first antenna 100 may be configured to include a first base substrate 110, the wireless power transmission antenna pattern 120, the short-range communication antenna pattern 130, the electronic payment antenna pattern 140, and a ground pattern 150.

The first base substrate 110 has a first dielectric loss value. As an example, the first base substrate 110 is made of polyimide (PI) and has a thickness of about 25 μm.

An upper surface of the first base substrate 110 is formed with an attachment area SA to which the second antenna 200 is attached. Here, the attachment area SA is an area that is formed by removing a part of a metal layer formed on the upper surface of the first base substrate 110 when the antenna is manufactured, and is an area where a surface of polyimide, which is the first base substrate 110, is exposed.

In other words, the first base substrate 110 is configured as a substrate in which a metal layer is formed on both surfaces or one surface of polyimide. The first base substrate 110 is formed with the attachment area SA by removing a part of the metal layer through a process of manufacturing the antenna.

The wireless power transmission antenna pattern 120 is disposed on upper and lower surfaces of the first base substrate 110. The short-range communication antenna pattern 130 and the electronic payment antenna pattern 140 are disposed on at least one of the upper surface and lower surface of the first base substrate 110.

At this time, the wireless power transmission antenna pattern 120, the short-range communication antenna pattern 130, and the electronic payment antenna pattern 140 may be formed by etching the first base substrate 110 having the metal layer formed on the upper surface and the lower surface.

Here, as an example, the wireless power transmission antenna pattern 120, the short-range communication antenna pattern 130, and the electronic payment antenna pattern 140 are made of a copper (Cu) material, and have a thickness of about 45 μm.

The ground pattern 150 is disposed on the lower surface of the first base substrate 110. The ground pattern 150 is disposed in an area overlapping the attachment area SA to which the second antenna 200 is attached. The ground pattern 150 overlaps the attachment area SA with the first base substrate 110 interposed therebetween. At this time, the ground pattern 150 may overlap all or a part of the attachment area SA.

Accordingly, the ground pattern 150 overlaps all or a part of the second antenna 200 disposed in the attachment area SA, and is connected to the second antenna 200 through a via hole or a through hole passing through the first base substrate 110.

The ground pattern 150 may be formed by etching a remaining area of the metal layer on the lower surface of the first base substrate 110 other than the area overlapping the attachment area SA.

At this time, as an example, the ground pattern 150 is made of a copper (Cu) material, and has a thickness of about 45 μm. Here, the ground pattern 150 may also be formed smaller than the thickness of the antenna pattern formed on the lower surface of the first base substrate 110 through an etching process.

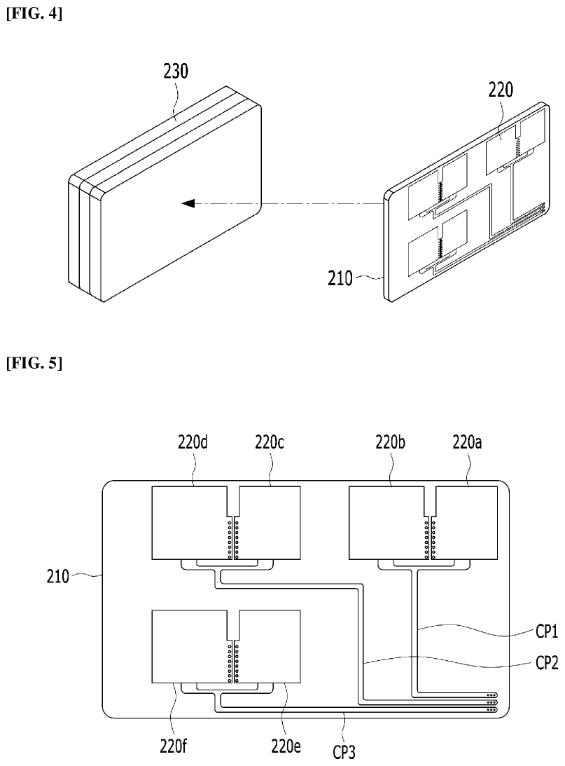

Referring to FIG. 4, the second antenna 200 includes an antenna pattern having an operation frequency different from that of the first antenna 100. At this time, as an example, the second antenna 200 includes an antenna pattern for ultra-wide band (UWB) communication. Accordingly, the second antenna 200 has a dielectric loss value lower than a dielectric loss value of the first antenna 100, and an operation frequency higher than an operation frequency of the first antenna 100.

The second antenna 200 is disposed on one surface of the first antenna 100. The second antenna 200 is disposed on the upper surface of the first base substrate 110, and disposed in the attachment area SA, which is an area on the upper surface of the first antenna 100 where the metal pattern is not formed.

The second antenna 200 may be configured to include a second base substrate 210, a UWB antenna pattern 220, and an adhesive substrate 230.

The second base substrate 210 has a dielectric loss value lower than the dielectric loss value of the first base substrate 110. As an example, the second base substrate 210 is made of a modified polyimide (MPI) having a lower dielectric loss value than that of polyimide, and has a thickness of about 25 μm.

The UWB antenna pattern 220 is disposed on an upper surface of the second base substrate 210. The UWB antenna pattern 220 has an operation frequency relatively higher than those of the wireless power transmission antenna pattern 120, the short-range communication antenna pattern 130, and the electronic payment antenna pattern 140 of the first antenna 100.

The UWB antenna pattern 220 may be made of a copper (Cu) material, and composed of a plurality of radiation electrodes having a thickness of about 12 μm. At this time, a plurality of radiation patterns is configured by forming two of the plurality of radiation electrodes as a pair, and each of the plurality of radiation patterns is connected to a different terminal.

As an example, referring to FIG. 5, the UWB antenna pattern 220 may be configured to include a first radiation electrode 220a, a second radiation electrode 220b, a third radiation electrode 220c, a fourth radiation electrode 220d, a fifth radiation electrode 220e, and a sixth radiation electrode 220f.

The first radiation electrode 220a and the second radiation electrode 220b are connected through a first connection pattern CP1 to configure one radiation pattern. The third radiation electrode 220c and the fourth radiation electrode 220d are connected through a second connection pattern CP2 to configure another radiation pattern. The fifth radiation electrode 220e and the sixth radiation electrode 220f are connected through a third connection pattern CP3 to configure another radiation pattern.

The adhesive substrate 230 is disposed on a lower surface of the second base substrate 210. The adhesive substrate 230 is interposed between the lower surface of the second base substrate 210 and the upper surface of the first base substrate 110 as the second antenna 200 is bonded to the first antenna 100.

The adhesive substrate 230 may also be configured as a laminate in which a plurality of adhesive sheets are stacked. At this time, as an example, the adhesive substrate 230 has a dielectric loss value lower than that of the first base substrate 110, and has a thickness of about 300 μm.

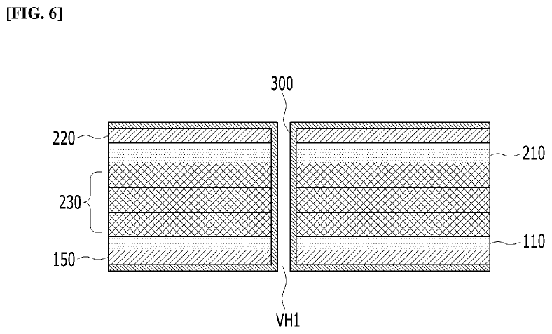

Meanwhile, referring to FIG. 6, the combo antenna module further includes a connection pattern 300 formed on an inner wall surface of a via hole passing through the first antenna 100 and the second antenna 200.

The connection pattern 300 connects the ground pattern 150 of the first antenna 100 and the UWB antenna pattern 220 of the second antenna 40. In other words, the connection pattern 300 electrically connects the ground pattern 150 disposed on the lower surface of the first base substrate 110 and the UWB antenna pattern 220 disposed on the upper surface of the second base substrate 210.

As an example, the connection pattern 300 may be a metal pattern formed on the inner wall surface of a via hole VH1 passing through the first base substrate 110 of the first antenna 100, the second base substrate 210 of the second antenna 200, and the adhesive substrate 230.

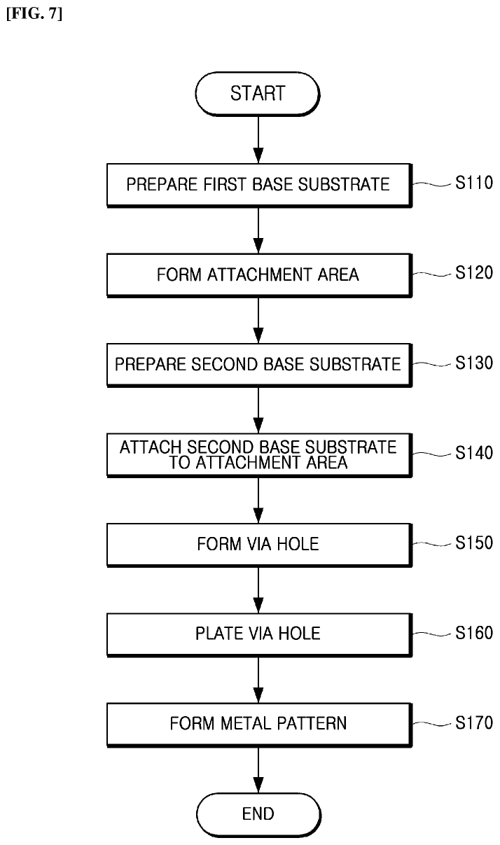

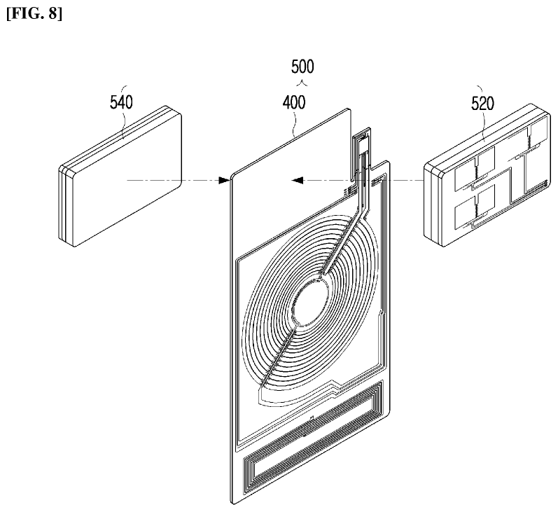

Referring to FIG. 7, a method of manufacturing the combo antenna module according to the first embodiment of the present disclosure is configured to include preparing a first base substrate 110 (S110), forming an attachment area (SA) (S100), preparing the second base substrate 210 (S130), attaching the second base substrate 210 to the attachment area SA (S200), forming the via hole VH1 (S300), plating the via hole VH1 (S160), and forming the metal pattern (S170).

In the preparing of the first base substrate 110 (S110), the first base substrate 110 in which the metal layers are formed on both surfaces (the upper surface and the lower surface) is prepared. Here, in the preparing of the first base substrate 110 (S110), as an example, a polyimide sheet in which the metal layers made of a copper material and having a thickness of about 45 μm are formed on the upper surface and the lower surface is prepared as the first base substrate 110.

In the forming of the attachment area SA (S100), the attachment area SA is formed by partially etching the metal layer on the upper surface of the first base substrate 110. Here, the attachment area SA is an area to which the second base substrate 210 is attached, and is formed by removing a part of the metal layer on the upper surface of polyimide sheet through the etching process.

In the preparing of the second base substrate 210 (S130), the second base substrate 210 having the lower dielectric loss value than that of the first base substrate 110 is prepared. In the preparing of the second base substrate 210 (S130), the metal layer made of the copper material is formed on the upper surface, and the modified polyimide sheet having the dielectric loss value lower than that of polyimide is prepared as the second base substrate 210.

In the attaching of the second base substrate 210 to the attachment area SA (S200), the second base substrate 210 is attached to the attachment area SA by compressing the attachment area SA of the first base substrate and the second base substrate 210 after the adhesive substrate 230 is interposed therebetween.

At this time, in the attaching of the second base substrate 210 to the attachment area SA (S200), the second base substrate 210 is attached to the attachment area SA using the adhesive substrate 230 having a thickness of about 300 μm. At this time, the adhesive substrate 230 may be configured by stacking a plurality of adhesive sheets.

In the forming of the via hole VH1 (S300), the via hole VH1 is formed through a punching process in a state in which the second base substrate 210 is attached to the attachment area SA of the first base substrate 110. At this time, in the forming of the via hole VH1 (S300), the via hole VH1 for connecting the wireless power transmission antenna patterns 120 disposed on each of both surfaces of the first base substrate 110, the via hole VH1 for connecting the UWB antenna disposed on the upper surface of the second base substrate 210 to the ground pattern 150 disposed on the lower surface of the first base substrate 110, and the like are formed.

In the plating of the via hole VH1 (S160), the metal is plated on the inner wall surface of the via hole VH1. In the plating of the via hole VH1 (S160), the connection pattern 300 is formed on the inner wall surface of the via hole VH1 by plating a copper through a plating process. Here, the connection pattern 300 electrically (directly) connects the metal layer on the upper surface of the second base substrate 210 and the metal layer on the lower surface of the first base substrate 110, or electrically (directly) connects the metal layers on the upper surface and lower surface of the first base substrate 110 according to positions.

Meanwhile, in the plating of the via hole VH1 (S160), in addition to the inner wall surface of the via hole VH1 in the plating process, a copper may be plated on the metal layer on the upper surface of the second base substrate 210 and a part (or all) of the metal layer on the lower surface of the first base substrate 110.

In the forming of the metal pattern (S170), the metal pattern is formed through the etching process after the via hole VH1 is completely plated.

In the forming of the metal pattern (S170), at least one of the wireless power transmission antenna pattern 120, the short-range communication antenna pattern 130, and the electronic payment antenna pattern 140 is formed on the upper surface of the first base substrate 110 through the etching process.

In the forming of the metal pattern (S170), at least one of the wireless power transmission antenna pattern 120, the short-range communication antenna pattern 130, and the electronic payment antenna pattern 140 and the ground pattern 150 are formed on the lower surface of the first base substrate 110 through the etching process. At this time, in the forming of the metal pattern (S170), the ground pattern 150 is formed in an area of the lower surface of the first base substrate 110 corresponding to the attachment area SA.

In the forming of the metal pattern (S170), the UWB antenna pattern 220 is formed on the upper surface of the second base substrate 210 through the etching process.

At this time, the UWB antenna pattern 220 and the ground pattern 150 formed through the forming of the metal pattern (S170) are directly (or electrically) connected by the connection pattern 300 formed on the inner wall surface of the via hole VH1 in operation S160.

Referring to FIG. 8, a combo antenna module according to a second embodiment of the present disclosure is configured to include a first antenna 400 and a second antenna 500. The first antenna 400 and the second antenna 500 have different dielectric loss values and operating frequencies. At this time, as an example, the first antenna 400 operates as an antenna resonating in at least one of a WPC frequency band, an NFC frequency band, and an MST frequency band, and the second antenna 500 operates as an antenna resonating in a UWB frequency band. Here, since the first antenna 400 is the same as the first antenna 100 (see FIGS. 2 and 3) of the above-described first embodiment, a detailed description thereof will be omitted.

The second antenna 500 is disposed on the upper surface and lower surface of the first antenna 400. At this time, the second antenna 500 has the dielectric loss value lower than the dielectric loss value of the first antenna 400, and the operation frequency higher than the operation frequency of the first antenna 400.

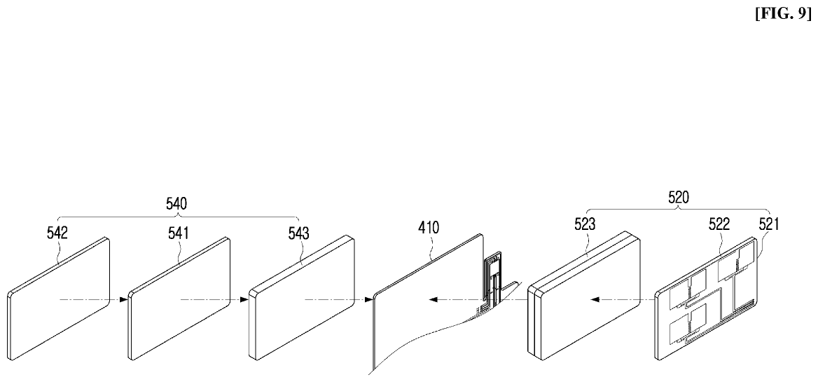

Referring to FIG. 9, the second antenna 500 is configured to include a first member 520 disposed on an upper surface of the first antenna 400 and a second member 540 disposed on a lower surface of the first antenna 400.

The first member 520 of the second antenna 500 is attached to a first attachment area SA1 of an upper surface of a first base substrate 410. The first member 520 includes a second base substrate 521, a UWB antenna pattern 522, and a first adhesive substrate 523.

The second base substrate 521 has a dielectric loss value lower than the dielectric loss value of the first base substrate 410. As an example, the second base substrate 521 is made of a modified polyimide (MPI) having a lower dielectric loss value than that of polyimide, and has a thickness of about 25 μm.

A lower surface of the second base substrate 521 is disposed to face the first base substrate 410. The second base substrate 521 is bonded to an upper surface of the first base substrate 410.

The UWB antenna pattern 522 is disposed on an upper surface of the second base substrate 521. The UWB antenna pattern 522 has an operation frequency relatively higher than those of the wireless power transmission antenna pattern 420, the short-range communication antenna pattern 430, and the electronic payment antenna pattern 440 of the first antenna 400.

Here, as an example, the UWB antenna pattern 522 is made of a copper (Cu) material, and is composed of a plurality of radiation electrodes having a thickness of about 12 μm. At this time, the plurality of radiation patterns is configured by forming two of the plurality of radiation electrodes as a pair, and each of the plurality of radiation patterns is connected to different terminals.

Since the UWB antenna pattern 522 is the same as the UWB antenna pattern 220 (see FIG. 5) of the above-described first embodiment, a detailed description thereof will be omitted.

The first adhesive substrate 523 is disposed on the lower surface of the second base substrate 521. The first adhesive substrate 523 is interposed between the lower surface of the second base substrate 521 and the upper surface of the first base substrate 410 as the second antenna 500 is bonded to the first antenna 400. At this time, the first adhesive substrate 523 may be configured as a laminate in which a plurality of adhesive sheets are stacked. Here, as an example, the first adhesive substrate 523 has a dielectric loss value lower than that of the first base substrate 410, and a thickness of about 100 μm.

The second member 540 of the second antenna 500 is disposed in a second attachment area SA2 of the lower surface of the first base substrate 410. The second member 540 is configured to include a third base substrate 541, a ground pattern 542, and a second adhesive substrate 543.

The third base substrate 541 has a dielectric loss value lower than that of the first base substrate 410. As an example, the third base substrate 541 is made of a modified polyimide (MPI) having a dielectric loss value lower than that of polyimide, and has a thickness of about 25 μm. The third base substrate 541 is bonded to the lower surface of the first base substrate 410.

The ground pattern 542 is disposed on a lower surface of the third base substrate 541. As an example, the ground pattern 542 is made of a copper material, and has a thickness of about 12 μm.

The second adhesive substrate 543 is disposed on an upper surface of the third base substrate 541. The second adhesive substrate 543 is interposed between the lower surface of the first base substrate 410 and the lower surface of the third base substrate 541 as the second antenna 500 is bonded to the first antenna 400. At this time, the second adhesive substrate 543 may be configured as a laminate in which a plurality of adhesive sheets is stacked. Here, as an example, the second adhesive substrate 543 has a dielectric loss value lower than that of the first base substrate 410, and has a thickness of about 50 μm.

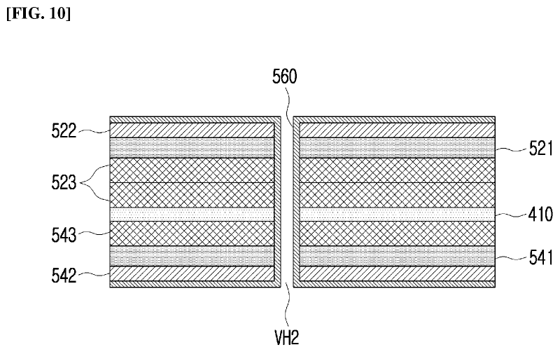

Meanwhile, referring to FIG. 10, the combo antenna module further includes a connection pattern 560 formed on the inner wall surface of the via hole VH2 passing through the first antenna 400 and the second antenna 500.

The connection pattern 560 connects the UWB antenna pattern 522 disposed on the upper surface of the second base substrate 521 and the ground pattern 542 disposed on the lower surface of the third base substrate 541. At this time, the connection pattern 560 may be a metal pattern formed on the inner wall surface of the via hole VH2 passing through the first base substrate 410 of the first antenna 400, the second base substrate 521 of the second antenna 500, the first adhesive substrate 523, the third base substrate 541, and the second adhesive substrate 543.

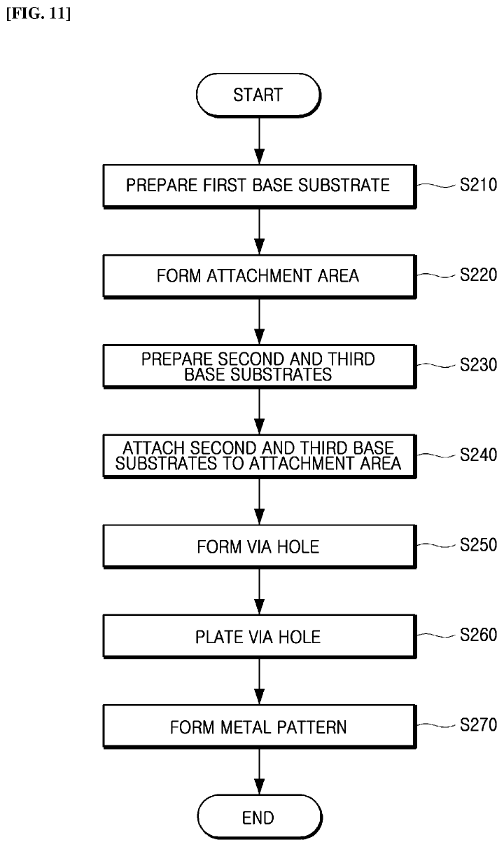

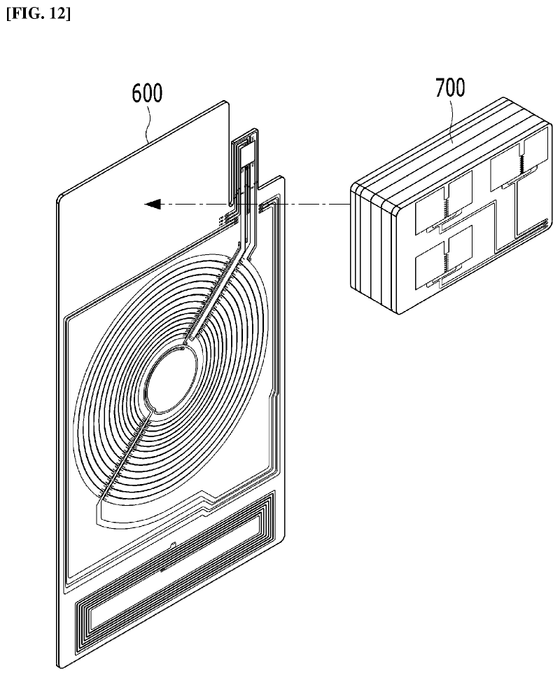

Referring to FIG. 11, the method of manufacturing the combo antenna module according to the second embodiment of the present disclosure is configured to include preparing the first base substrate 410 (S210), forming the attachment area (S220), preparing the second base substrate 521 and the third base substrate 541 (S230), attaching the second base substrate 521 and the third base substrate 541 to the attachment area (S240), forming the via hole VH2 (S260), plating the via hole VH2 (S260), and forming the metal pattern (S270).

In the preparing of the first base substrate 410 (S210), the first base substrate 410 in which the metal layers are formed on both surfaces (the upper surface and the lower surface) is prepared. Here, in the preparing of the first base substrate 410 (S210), as an example, a polyimide sheet in which the metal layers made of a copper material and having a thickness of about 45 μm are formed on the upper surface and the lower surface is prepared as the first base substrate 410.

In the forming of the attachment area (S220), the first attachment area SA1 is formed by partially etching the metal layer on the upper surface of the first base substrate 410. Here, the first attachment area SA1 is an area to which the first member 520 of the second antenna 500 is attached, and is formed by removing a part of the metal layer on the upper surface of polyimide sheet through the etching process.

In the forming of the attachment area (S220), the second attachment area SA2 is formed by partially etching the metal layer on the lower surface of the first base substrate 410. Here, the second attachment area SA2 is an area to which the second member 540 of the second antenna 500 is attached, and is formed by removing a part of the metal layer on the lower surface of polyimide sheet through the etching process.

In the preparing of the second base substrate 521 and the third base substrate 541 (S230), the second base substrate 521 and the third base substrate 541 having a dielectric loss value lower than that of the first base substrate 410 are prepared. In the preparing of the second base substrate 521 and the third base substrate 541 (S230), the metal layer made of a copper material is formed on the upper surface, and a modified polyimide sheet having a dielectric loss value lower than that of polyimide is prepared as the second base substrate 521 and the third base substrate 541.

In the attaching of the second base substrate 521 and the third base substrate 541 to the attachment area (S240), the second base substrate 521 is attached to the first attachment area SA1 by compressing the first attachment area SA1 of the first base substrate and the second base substrate 521 after the first adhesive substrate 523 is interposed therebetween.

In the attaching of the second base substrate 521 and the third base substrate 541 to the attachment area (S240), the third base substrate 541 is attached to the second attachment area SA2 by compressing the second attachment area SA2 of the first base substrate and the third base substrate 541 after the second adhesive substrate 543 is interposed therebetween.

At this time, in the attaching of the second base substrate 521 and the third base substrate 541 to the attachment area (S240), the second base substrate 521 and the third base substrate 541 may also be simultaneously attached to the first base substrate 410.

At this time, in the attaching of the second base substrate 521 to the attachment area (S240), the second base substrate 521 is attached to the first attachment area SA1 using the first adhesive substrate 523 having a thickness of about 100 μm, and the third base substrate 541 is attached to the second attachment area SA2 using the second adhesive substrate 543 having a thickness of about 50 μm. Here, the first adhesive substrate 523 and/or the second adhesive substrate 543 may be configured by stacking a plurality of adhesive sheets.

In the forming of the via hole VH2 (S260), the via hole VH2 is formed through a punching process in a state in which the second base substrate 521 and the third base substrate 541 are bonded to the first base substrate 410. At this time, in the forming of the via hole VH2 (S260), the via hole VH2 for connecting the wireless power transmission antenna patterns 420 disposed on each of both surfaces of the first base substrate 410, the via hole VH2 for connecting the UWB antenna disposed on the upper surface of the second base substrate 521 to the ground pattern 542 disposed on the upper surface of the third base substrate 541, and the like are formed.

In the plating of the via hole VH2 (S260), the metal is plated on the inner wall surface of the via hole VH2. In the plating of the via hole VH2 (S260), the connection pattern 560 is formed on the inner wall surface of the via hole VH2 by plating a copper through the plating process. Here, a plurality of connection patterns 560 is configured and electrically (directly) connect the metal layer on the upper surface of the second base substrate 521 and the metal layer on the upper surface of the third base substrate 541, or electrically (directly) connect the metal layers of the upper surface and lower surface of the first base substrate 410 according to positions.

Meanwhile, in the plating of the via hole VH2 (S260), in the plating process, a copper may be plated on the metal layer on the lower surface of the first base substrate 410, the metal layer on the upper surface of the second base substrate 521, and a part (or all) of the metal layer on the upper surface of the second base substrate 521 in addition to the inner wall surface of the via hole VH2.

In the forming of the metal pattern (S270), the metal pattern is formed through the etching process after the via hole VH2 is completely plated.

In the forming of the metal pattern (S270), at least one of the wireless power transmission antenna pattern 420, the short-range communication antenna pattern 430, and the electronic payment antenna pattern 440 is formed on the upper surface of the first base substrate 410 through the etching process.

In the forming of the metal pattern (S270), at least one of the wireless power transmission antenna pattern 420, the short-range communication antenna pattern 430, and the electronic payment antenna pattern 440 is formed on the lower surface of the first base substrate 410 through the etching process.

In the forming of the metal pattern (S270), the UWB antenna pattern 522 is formed on the upper surface of the second base substrate 521, and the ground pattern 542 is formed on the lower surface of the third base substrate 541 through the etching process. At this time, the UWB antenna pattern 522 and the ground pattern 542 formed through the forming of the metal pattern (S270) are directly (or electrically) connected by the connection pattern 560 formed on the inner wall surface of the via hole VH2 in operation S260.

Referring to FIG. 12, a combo antenna module according to a third embodiment of the present disclosure is configured to include a first antenna 600 and a second antenna 700. The first antenna 600 and the second antenna 700 have different dielectric loss values and operating frequencies. At this time, as an example, the first antenna 600 operates as an antenna resonating in at least one of a WPC frequency band, an NFC frequency band, and an MST frequency band, and the second antenna 700 operates as an antenna resonating in an UWB frequency band. Here, since the first antenna 600 is the same as the first antenna 100 (see FIGS. 2 and 3) of the above-described first embodiment, a detailed description thereof will be omitted.

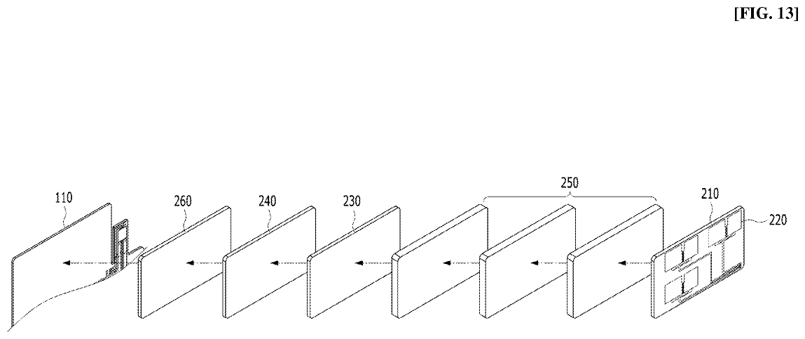

Referring to FIG. 13, the second antenna 700 includes an antenna pattern having an operation frequency different from that of the first antenna 600. At this time, as an example, the second antenna 700 includes an antenna pattern for ultra-wide band (UWB) communication. Accordingly, the second antenna 700 has a dielectric loss value lower than a dielectric loss value of the first antenna 600, and an operation frequency higher than an operation frequency of the first antenna 600.

The second antenna 700 is disposed on one surface of the first antenna 600. The second antenna 700 is formed in the attachment area SA that is an area of one surface of the first antenna 600 in which the metal pattern is not formed. At this time, the second antenna 700 has the dielectric loss value lower than that of the first antenna 600, and the operation frequency higher than that of the first antenna 600.

The second antenna 700 is configured to include a second base substrate 710, a UWB antenna pattern 720, a third base substrate 730, a ground pattern 740, a first adhesive substrate 750, and a second adhesive substrate 760.

The second base substrate 710 has a dielectric loss value lower than the dielectric loss value of the first base substrate 610. As an example, the second base substrate 710 is made of a modified polyimide (MPI) having a lower dielectric loss value than that of polyimide, and has a thickness of about 25 μm.

The UWB antenna 720 is disposed on an upper surface of the second base substrate 710. The UWB antenna pattern 720 has an operation frequency relatively higher than those of a wireless power transmission antenna pattern 620, a short-range communication antenna pattern 630, and an electronic payment antenna pattern 640 of the first antenna 600.

The UWB antenna pattern 720 may be made of a copper (Cu) material, and composed of a plurality of radiation electrodes having a thickness of about 12 μm. At this time, the plurality of radiation patterns is configured by forming two of the plurality of radiation electrodes as a pair, and each of the plurality of radiation patterns is connected to a different terminal.

Since the UWB antenna pattern 720 is the same as the UWB antenna pattern 220 (see FIG. 5) of the above-described first embodiment, a detailed description thereof will be omitted.

The third base substrate 730 has a dielectric loss value lower than that of the first base substrate 610. As an example, the third base substrate 730 is made of a modified polyimide (MPI) having a dielectric loss value lower than that of polyimide, and has a thickness of about 25 μm.

The ground pattern 740 is disposed on a lower surface of the third base substrate 730. The ground pattern 740 is configured as a metal layer on the lower surface of the third base substrate 730. Here, as an example, the ground pattern 740 is a metal layer made of a copper (Cu) material and having a thickness of about 12 μm.

The ground pattern 740 overlaps the UWB antenna pattern 720 with the third base substrate 730 and the first adhesive substrate 750 interposed therebetween. At this time, the ground pattern 740 overlaps all or a part of the UWB antenna pattern 720, and is connected to the UWB antenna pattern 720 through a via hole, a through hole, and the like passing through the second base substrate 710, the third base substrate 730, and the first adhesive substrate 750.

The first adhesive substrate 750 is interposed between a lower surface of the second base substrate 710 and a lower surface of the third base substrate 730. The first adhesive substrate 750 may be configured as a laminate in which a plurality of adhesive sheets are stacked. Here, as an example, the first adhesive substrate 750 has a dielectric loss value lower than that of the first base substrate 610, and a thickness of about 150 μm.

The second adhesive substrate 760 is disposed on an upper surface of the third base substrate 730. The second adhesive substrate 760 is interposed between the upper surface of the third base substrate 730 and the upper surface of the first base substrate 610 as the second antenna 700 is bonded to the first antenna 600.

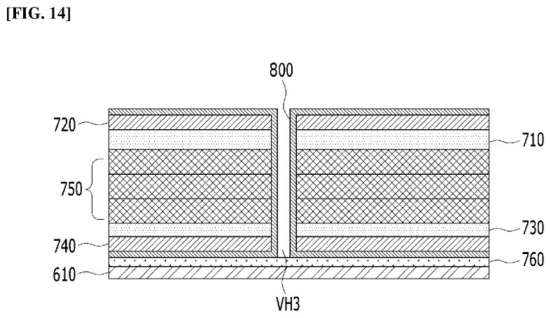

Referring to FIG. 14, the combo antenna module further includes the connection pattern 300 formed on an inner wall surface of a via hole VH3 passing through the second antenna 700. The connection pattern 300 is a metal pattern formed on the inner wall surface of the via hole VH3 passing through the second base substrate 710, the third base substrate 730, and the first adhesive substrate 750 of the second antenna 700. The connection pattern 300 connects the UWB antenna pattern 720 disposed on the upper surface of the second base substrate 710 and the ground pattern 740 disposed on the lower surface of the third base substrate 730.

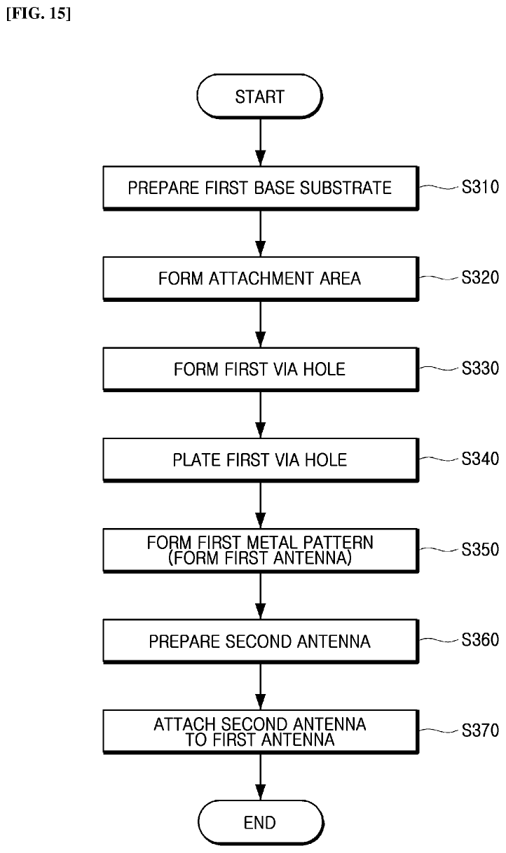

Referring to FIG. 15, a method of manufacturing the combo antenna module according to the third embodiment of the present disclosure is configured to include preparing the first base substrate 610 (S310), forming the attachment area SA (S320), forming the first via hole (S330), plating the first via hole (S340), forming a first metal pattern (S350), preparing the second antenna 700 (S330), and attaching the second antenna 700 to the first antenna 600 (S370).

In the preparing of the first base substrate 610 (S310), the first base substrate 610 in which the metal layers are formed on both surfaces (the upper surface and the lower surface) is prepared. Here, in the preparing of the first base substrate 610 (S310), as an example, a polyimide sheet in which the metal layers made of a copper material having a thickness of about 45 μm are formed on the upper surface and the lower surface is prepared as the first base substrate 610.

In the forming of the attachment area SA (S320), the attachment area SA is formed by partially etching the metal layer on the upper surface of the first base substrate 610. Here, the attachment area SA is an area to which the second antenna 700 is attached, and formed by removing a part of the metal layer on the upper surface of the polyimide sheet through the etching process.

In the forming of the first via hole (S330), the first via hole is formed in the first base substrate 610 through the punching process. At this time, in the forming of the first via hole (S330), the first via hole for connecting the metal layers disposed on each of both surfaces of the first base substrate 610 is formed.

Meanwhile, in the plating of the first via hole (S330), in the plating process, a copper may be plated on a part (or all) of the metal layers on the upper and lower surfaces of the first base substrate 610 in addition to the inner wall surface of the via hole.

In the plating of the first via hole (S340), a metal is plated on the inner wall surface of the first via hole. In the plating of the first via hole (S340), a copper is plated through the plating process to plate the inner wall surface of the first via hole to electrically (directly) connect the metal layer on the upper surface and metal layer on the lower surface of the first base substrate 610.

In the forming of the first metal pattern (S350), the first metal pattern is formed through the etching process after the via hole is completely plated.

In the forming of the first metal pattern (S350), the first metal pattern of at least one of the wireless power transmission antenna pattern 620, the short-range communication antenna pattern 630, and the electronic payment antenna pattern 640 is formed on the upper surface of the first base substrate 610 through the etching process.

In the forming of the first metal pattern (S350), the first metal pattern of at least one of the wireless power transmission antenna pattern 620, the short-range communication antenna pattern 630, and the electronic payment antenna pattern 640 is formed on the lower surface of the first base substrate 610 through the etching process.

In the method of manufacturing the combo antenna module, the first antenna 600 resonating in at least one of the WPC frequency band, the NFC frequency band, and the MST frequency band is formed through operations S310 and S320 described above.

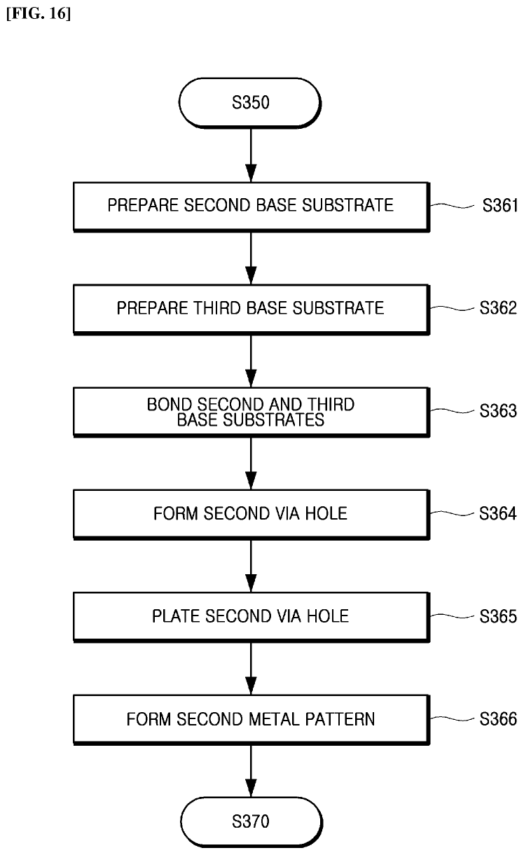

Referring to FIG. 16, the preparing of the second antenna 700 (S360) includes preparing the second base substrate 710 (S361), preparing the third base substrate 730 (S362), bonding the second base substrate 710 and the third base substrate 730 (S363), forming the second via hole VH3 (S364), plating the second via hole VH3 (S365), and forming a second metal pattern (S366).

In the preparing of the second base substrate 710 (S361), the second base substrate 710 having the lower dielectric loss value than that of the first base substrate 610 is prepared. In the preparing of the second base substrate 710 (S361), the metal layer made of the copper material is formed on the upper surface, and the modified polyimide sheet having the dielectric loss value lower than that of polyimide is prepared as the second base substrate 710.

In the preparing of the third base substrate 730 (S362), the third base substrate 730 having a lower dielectric loss value than that of the first base substrate 610 is prepared. In the preparing of the third base substrate 730 (S362), a metal layer made of a copper material is formed on the lower surface, and a modified polyimide sheet having a dielectric loss value lower than that of polyimide is prepared as the third base substrate 730.

In the bonding of the second base substrate 710 and the third base substrate 730 (S363), the second base substrate 710 and the third base substrate 730 are attached by compressing the second base substrate 710 and the third base substrate 730 after the first adhesive substrate 750 is interposed therebetween. At this time, the first adhesive substrate 750 may be configured by laminating a plurality of adhesive sheets, and has a thickness of about 150 μm.

In the forming of the second via hole VH3 (S364), the second via hole VH3 passing through the second base substrate 710 and the third base substrate 730 is formed through the punching process. At this time, in the forming of the second via hole VH3 (S364), the second via hole VH3 for connecting the metal layer of the second base substrate 710 and the metal layer of the third base substrate 730 is formed.

In the plating of the second via hole VH3 (S365), a metal is plated on an inner wall surface of the second via hole VH3. In the plating of the second via hole VH3 (S365), a copper is plated through the plating process to form the connection pattern 300 on the inner wall surface of the second via hole VH3. Here, the connection pattern 300 electrically (directly) connects the metal layer of the second base substrate 710 and the metal layer of the third base substrate 730.

Meanwhile, in the plating of the second via hole VH3 (S364), in the plating process, a copper may be plated on a part (or all) of the metal layer of the second base substrate 710 and a part (or all) of the metal layer of the third base substrate 730 in addition to the inner wall surface of the via hole.

In the forming of the second metal pattern (S366), the UWB antenna pattern 720 is formed on the upper surface of the second base substrate 710 through the etching process. At this time, the UWB antenna pattern 720 formed through the forming of the second metal pattern (S366) is directly (or electrically) connected to the metal layer (i.e., the ground pattern 740) of the third base substrate 730 by the connection pattern 300 formed on the inner wall surface of the via hole in operation S365.

In the bonding of the second antenna 700 to the first antenna 600 (S370), the second antenna 700 is attached to the attachment area SA of the first antenna 600. In the bonding of the second antenna 700 to the first antenna 600 (S370), the second antenna 700 is attached to the attachment area SA of the first base substrate 610 by compressing the attachment area SA of the first antenna 320 (i.e., the first base substrate 610) and the lower surface of the second antenna 700 after the second adhesive substrate 760 is interposed therebetween.

In the third embodiment, the second antenna 700 has been described as being configured in a single-layer structure as an example, but is not limited thereto and may also be formed in a double-sided structure or a multi-layer structure.

Although the preferred embodiments of the present disclosure have been described above, it is understood that the present disclosure can be modified in various forms, and those skilled in the art can practice various modified examples and changed examples without departing from the scope of the claims of the present disclosure.

1. A combo antenna module comprising:
a first antenna including a first antenna pattern having a first operation frequency, a first base substrate having the first antenna pattern disposed thereon, and having an attachment area not overlapping the first antenna pattern defined therein; and
a second antenna including a second antenna pattern having a second operation frequency higher than the first operation frequency, and disposed in the attachment area defined in the first antenna, and
wherein the attachment area includes a first attachment area defined on an upper surface of the first base substrate, and a second attachment area defined on a lower surface of the first base substrate; and
wherein the second antenna includes:
a first member having the second antenna pattern, and disposed on the first attachment area; and
a second member having a ground pattern disposed on a lower surface, and disposed on the second attachment area.

2. The combo antenna module of claim 1,
wherein the first member includes:
a second base substrate having the second antenna pattern disposed on an upper surface; and
a first adhesive substrate interposed between a lower surface of the second base substrate and the upper surface of the first base substrate to bond the second base substrate to the first attachment area.

3. The combo antenna module of claim 2,
wherein the second member includes:
a third base substrate having a dielectric loss value of the first base substrate lower than a first dielectric loss value, and having the ground pattern disposed on a lower surface; and
a second adhesive substrate interposed between an upper surface of the third base substrate and the lower surface of the first base substrate to bond the third base substrate to the second attachment area.

4. The combo antenna module of claim 3, further comprising:
a connection pattern connecting the second antenna pattern and the ground pattern by passing through the first member, the first base substrate, and the second member.

5. A method of manufacturing a combo antenna module, the method comprising:
preparing a first antenna including a first base substrate having a first antenna pattern disposed thereon;
forming an attachment area not overlapping the first antenna pattern on the first base substrate,
wherein the forming of the attachment area includes forming a first attachment area on an upper surface of the first base substrate, and forming a second attachment area on a lower surface of the first base substrate;
preparing a second antenna having a second operation frequency higher than a first operation frequency of the first antenna,
wherein the preparing of the second antenna includes preparing a first member having a second antenna pattern, and preparing a second member having a ground pattern disposed on a lower surface; and
disposing the first member on the first attachment area, and disposing the second member on the second attachment area.

6. The method of claim 5, wherein the preparing of the first member includes preparing a second base substrate having the second antenna pattern disposed on an upper surface; and the disposing of the first member includes interposing a first adhesive substrate between a lower surface of the second base substrate and the upper surface of the first base substrate to bond the second base substrate to the first attachment area.

7. The method of claim 6, wherein the preparing of the second member includes preparing a third base substrate having a dielectric loss value of the first base substrate lower than a first dielectric loss value, and having the ground pattern disposed on a lower surface; and the disposing of the second member includes interposing a second adhesive substrate between an upper surface of the third base substrate and the lower surface of the first base substrate to bond the third base substrate to the second attachment area.

8. The method of claim 7, further comprising:
forming a connection pattern connecting the second antenna pattern and the ground pattern by forming a via hole passing through the first member, the first base substrate, and the second member, and
forming a metal layer in the via hole.
